(19) United States
(12) Patent Application Publication
(10) Pub. No.: US 2024/0079683 A1
(43) Pub. Date: Mar. 7, 2024

(54) THERMAL BARRIER LOCATING FEATURES FOR USE WITHIN TRACTION BATTERY PACKS

(71) Applicant: FORD GLOBAL TECHNOLOGIES, LLC, Dearborn, MI (US)

(72) Inventors: Mohammadreza Eftekhari, Novi, MI (US); Kevin Durand Byrd, Novi, MI (US); Kanchana Perumalla, Troy, MI (US)

(21) Appl. No.: 18/176,719

(22) Filed: Mar. 1, 2023

Related U.S. Application Data
(60) Provisional application No. 63/403,445, filed on Sep. 2, 2022.

(51) Int. Cl. H01M 10/658; H01M 10/6551; H01M 10/6556; H01M 50/342

(52) U.S. Cl. CPC H01M 10/658; H01M 10/6551; H01M 10/6556; H01M 50/342; H01M 10/613

(57) ABSTRACT

Thermal barrier assemblies are provided for traction battery packs. An exemplary thermal barrier assembly may be configured to block or even prevent thermal energy associated with a battery thermal event from moving from cell-to-cell, compartment-to-compartment, and/or cell stack-to-cell stack within the traction battery pack. The thermal barrier assembly may include a locator configured to locate the thermal barrier assembly relative to a heat exchanger plate of the traction battery pack. The locator may at least partially fill and seal a slot formed in the heat exchanger plate.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to thermal barrier assemblies that include features for interfacing with a slotted heat exchanger plate within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack, a thermal barrier assembly arranged between a first battery cell and a second battery cell of the cell stack, a heat exchanger plate positioned adjacent to the cell stack, and a locator of the thermal barrier assembly received within a slot of the heat exchanger plate.

In a further non-limiting embodiment of the foregoing traction battery pack, the first battery cell, the second battery cell, and the thermal barrier assembly are arranged between a first cross-member beam and a second cross-member of the cell stack.

In a further non-limiting embodiment of either of the foregoing traction battery packs, a third cross-member beam is adjacent to the first cross-member beam. The first cross-member beam and the third cross-member beam establish a cross-member assembly arranged between the cell stack and a second cell stack of the traction battery pack.

In a further non-limiting embodiment of any of the foregoing traction battery packs, a venting passageway is disposed between the first cross-member beam and the third cross-member beam.

In a further non-limiting embodiment of any of the foregoing traction battery packs, the thermal barrier assembly includes a fin section configured to interface with an enclosure cover.

In a further non-limiting embodiment of any of the foregoing traction battery packs, the fin section is located on an opposite end of the thermal barrier assembly from the locator.

In a further non-limiting embodiment of any of the foregoing traction battery packs, the fin section is secured to the enclosure cover by an adhesive.

In a further non-limiting embodiment of any of the foregoing traction battery packs, a thermal interface material is between the cell stack and the heat exchanger plate.

In a further non-limiting embodiment of any of the foregoing traction battery packs, a projecting prong of the locator extends through the thermal interface material and at least partially fills the slot.

In a further non-limiting embodiment of any of the foregoing traction battery packs, the slot establishes a thermal break between the first battery cell and the second battery cell.

In a further non-limiting embodiment of any of the foregoing traction battery packs, the locator includes a solid plastic.

In a further non-limiting embodiment of any of the foregoing traction battery packs, the locator includes a compliant rubber.

A traction battery pack according to another exemplary aspect of the present disclosure includes, among other things, a cell stack, a thermal barrier assembly arranged between a first battery cell and a second battery cell of the cell stack, a heat exchanger plate positioned adjacent to the cell stack and including a slot configured to establish a thermal break between the first battery cell and the second battery cell, and a locator of thermal barrier assembly positioned to at least partially fill the slot.

In a further non-limiting embodiment of the foregoing traction battery pack, the thermal barrier assembly includes a fin section configured to interface with an enclosure cover.

In a further non-limiting embodiment of either of the foregoing traction battery packs, the fin section is located on an opposite end of the thermal barrier assembly from the locator.

In a further non-limiting embodiment of any of the foregoing traction battery packs, a thermal interface material is between the cell stack and the heat exchanger plate.

In a further non-limiting embodiment of any of the foregoing traction battery packs, a projecting prong of the locator extends through the thermal interface material and at least partially fills the slot.

In a further non-limiting embodiment of any of the foregoing traction battery packs, the projecting prong protrudes outwardly from a base portion of the locator.

In a further non-limiting embodiment of any of the foregoing traction battery packs, the locator includes a solid plastic.

In a further non-limiting embodiment of any of the foregoing traction battery packs, the locator includes a compliant rubber.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view through section 3-3 of FIG. 2.

FIG. 4 illustrates an interface between a thermal barrier assembly and a heat exchanger plate of a traction battery pack.

FIG. 5 illustrates another exemplary thermal barrier assembly.

FIG. 6 illustrates another exemplary thermal barrier assembly.

FIG. 7 illustrates another exemplary thermal barrier assembly.

FIG. 8 illustrates another exemplary thermal barrier assembly.

FIG. 9 illustrates yet another exemplary thermal barrier assembly.

### DETAILED DESCRIPTION

This disclosure details thermal barrier assemblies for traction battery packs. An exemplary thermal barrier assembly may be configured to block or even prevent thermal energy associated with a battery thermal event from moving from cell-to-cell, compartment-to-compartment, and/or cell stack-to-cell stack within the traction battery pack. The thermal barrier assembly may include a locator configured to locate the thermal barrier assembly relative to a heat exchanger plate of the traction battery pack. The locator may at least partially fill and seal a slot formed in the heat exchanger plate. These and other features are discussed in greater detail in the following paragraphs of this detailed description.

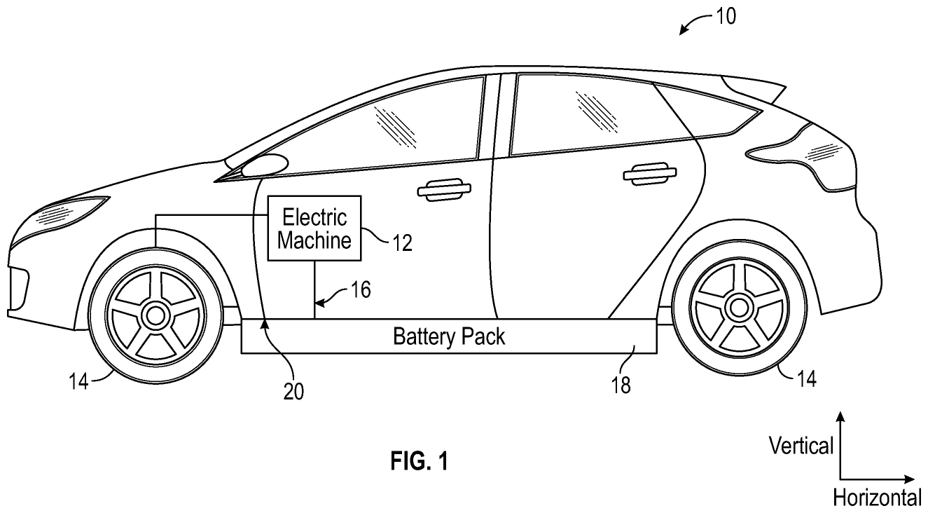

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

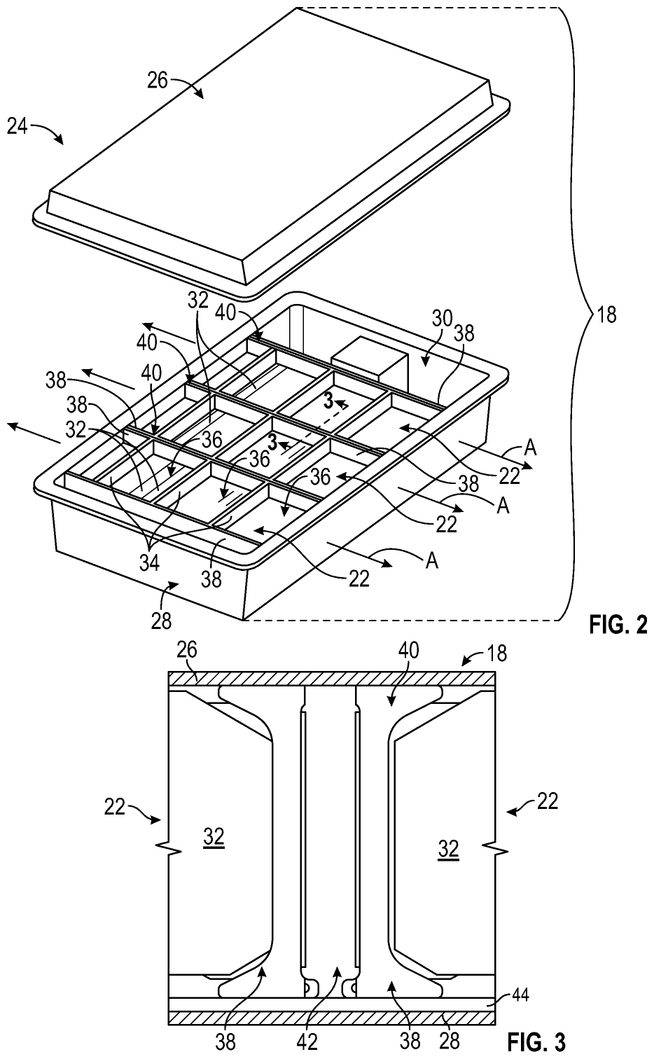

FIGS. 2 and 3 illustrate additional details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cells stacks 22 and other battery internal components.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals extending from a battery cell housing. An aluminum film may provide the battery cell housing, for example.

The battery cells 32 of each cell stack 22 may be arranged between a pair of cross-member beams 38. The cross-member beams 38 may be configured to support the battery cells 32 and at least partially delineate the cell stacks 22.

Immediately adjacent-cross member beams 38 may establish a cross-member assembly 40 disposed between adjacent cell stacks 22 of the traction battery pack 18. The cross-member assemblies 40 may be configured to transfer a load applied to a side of the electrified vehicle 10, for example. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

The cross-member assemblies 40 may also establish a battery pack venting system for communicating battery cell vent byproducts from the traction battery pack 18 during battery thermal events. For example, the cross-member assemblies 40 may establish passageways 42 (best shown in FIG. 3) that can communicate battery cell vent byproducts from the cell stacks 22 toward a position where the battery cell vent byproducts can be expelled from the traction battery pack 18.

In the exemplary embodiment, first and second adjacent cross-member beams 38 may establish a first side and a second side, respectively, of the passageway 42 of the cross-member assembly 40. Further, a vertically upper side of the passageway 42 may be established by the enclosure cover 26 (see FIG. 3), and a vertically lower side of the passageway 42 may be established by a heat exchanger plate 44 positioned against the enclosure tray 28 (see FIG. 3). In another embodiment, the heat exchanger plate 44 may be omitted and the vertically lower side of the passageway 42 may be established by the enclosure tray 28. Vertical and horizontal, for purposes of this disclosure, are with reference to ground and a general orientation of traction battery pack 18 when installed within the electrified vehicle 10 of FIG. 1.

Each cross-member beam 38 may include one or more openings (not shown) for communicating the battery cell vent byproducts through the beams and into the passageway 42. The openings thus provide a vent path for battery cell vent byproducts to move to the passageways 42 as required. Each cross-member beam 38 may additionally include one or more openings (not shown) for accommodating cell tabs of the battery cells 32.

The cross-member beams 38 may be adhesively secured to the enclosure cover 26 and to the heat exchanger plate 44 and/or enclosure tray 28. The adhesive can seal these interfaces to inhibit battery cell vent byproducts escaping the passageway 42 through these areas.

In an embodiment, the cells stacks 22, the cross-member assemblies 40, and the respective passageways 42 extend longitudinally in a cross-vehicle direction in a mounted position of the traction battery pack 18. However, other configurations and orientations are further contemplated within the scope of this disclosure.

One or more thermal barrier assemblies 34 may be arranged along the respective cell stack axis A of each cell stack 22. The thermal barrier assemblies 34 may divide or compartmentalize each cell stack 22 into two or more groupings or compartments 36 of battery cells 32. Should, for example, a battery thermal event occur in one of the cell stacks 22, the thermal barrier assemblies 34 may block or even prevent thermal energy associated with the thermal event from moving from cell-to-cell, compartment-to-compartment, and/or cell stack-to-cell stack, thereby inhibiting thermal propagation inside the traction battery pack 18.

Each compartment 36 may hold one or more of the battery cells 32 of one of the cell stacks 22. In an embodiment, the battery cells 32 of each cell stack 22 are held within one of four compartments 36. However, other configurations, including configurations that utilize a greater or fewer number of thermal barrier assemblies 34 and compartments 36, could be used within the scope of this disclosure.

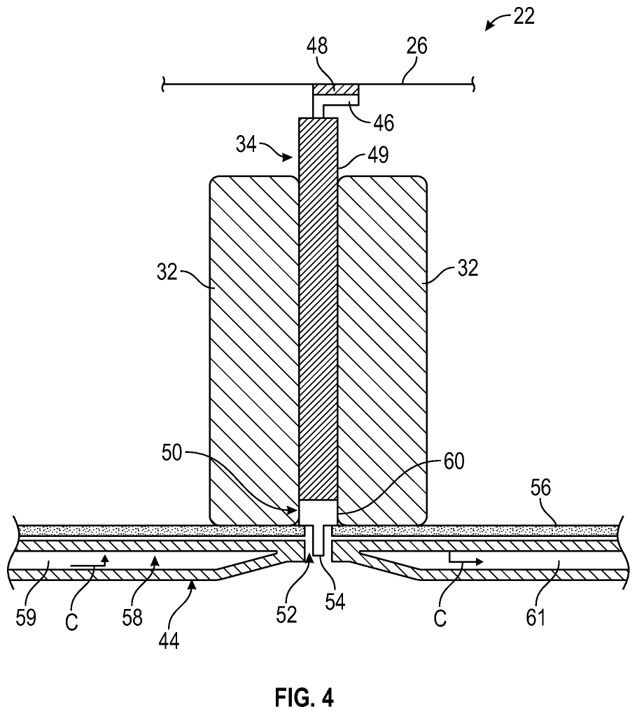

FIG. 4, with continued reference to FIGS. 2-3, illustrates details associated with one of the thermal barrier assemblies 34 of the traction battery pack 18. The additional thermal barrier assemblies of the traction battery pack 18 could include an identical design to the thermal barrier assembly 34 shown in FIG. 4.

The thermal barrier assembly 34 may include a single-piece structure or a multi-layered sandwich structure that is configured to slow or even prevent thermal propagation from cell-to-cell and/or compartment-to-compartment across the cell stack 22. In an embodiment, the thermal barrier assembly 34 is made of a metallic material, such as stainless steel or aluminum, for example. In another embodiment, the thermal barrier assembly 34 includes an insulating material(s), such as aerogel materials or foam materials. However, other material or combinations of materials could with utilized to provide the thermal barrier assembly 34 with insulative properties within the scope of this disclosure.

The exemplary thermal barrier assembly 34 may include a fin section 46 configured to interface with the enclosure cover 26. The fin section 46 may be integral with or attached to a housing 49 of the thermal barrier assembly 34. The fin section 46 may be made of a metallic material. In an embodiment, the fin section 46 is made of stainless steel. In another embodiment, the fin section 46 is made of aluminum. The fin section 46 may be coated with a high temperature resistance and thermally nonconductive coating to limit thermal heat transfer short-circuiting. However, other materials including high temperature resistance thermoplastic and thermoset composites could be utilized to construct the fin section 46 of the thermal barrier assembly 34 within the scope of this disclosure.

The fin section 46 may be fixedly secured to the enclosure cover 26 to increase the overall rigidity of the traction battery pack 18. An adhesive 48 may be utilized to secure the fin section 46 to the enclosure cover 26. The adhesive 48 may be an epoxy based adhesive or a urethane based adhesive, for example.

The thermal barrier assembly 34 may further include a locator 50 that is disposed on an opposite end of the thermal barrier assembly 34 from the fin section 46. The locator 50 may be made of a solid plastic or a compliance rubber, for example. The locator 50 may be configured to interface with the heat exchanger plate 44 and can be used as an assembly aid. The locator 50 may further be configured for sealing an interface between the thermal barrier assembly 34 and the heat exchanger plate 44 and increasing the overall stiffness of the heat exchanger plate 44.

In an embodiment, the locator 50 includes a T-shaped cross-section. However, other cross-sectional shapes are contemplated within the scope of this disclosure.

The heat exchanger plate 44 may include one or more slots 52 sized to receive the locator 50. The slot 52 may establish a thermal break between neighboring battery cells 32 of the cell stack 22 within which the thermal barrier assembly 34 is disposed. The locator 50 may be positioned such that a projecting prong 54 of the locator 50 is at least partially received within the slot 52. Therefore, in addition to acting as a locating feature for locating the thermal barrier assembly 34 relative to the heat exchanger plate 44, the locator 50 may at least partially fill the slot 52 in order to seal the interface between the thermal barrier assembly 34 and the heat exchanger plate 44.

A thermal interface material 56 may be disposed between the battery cells 32 and the heat exchanger plate 44. In an embodiment, downwardly facing bottom surfaces of the battery cells 32 are in direct contact with the fusible thermal interface material 56. However, other configurations are contemplated within the scope of this disclosure. The thermal interface material 56 may be configured to fixedly secure the battery cells 32 and the thermal barrier assembly 34 in place relative to the heat exchanger plate 44.

The thermal interface material 56 may be further configured to maintain thermal contact between the battery cells 32 and the heat exchanger plate 44, thereby facilitating thermal conductivity between these neighboring components during heat transfer events. Heat conducted from the battery cells 32 to the heat exchanger plate 44 may then be carried away from the battery cells 32 by a coolant C that is circulated within an internal coolant circuit 58 of the heat exchanger plate 44.

In the cross-sectional view of FIG. 4, the internal coolant circuit 58 is configured such that the coolant C flows into and out of the page. The slot 52 may be disposed between adjacent fluidly connected passes 59, 61 of the internal coolant circuit 58. However, other configurations are contemplated within the scope of this disclosure.

The projecting prong 54 may extend outwardly (e.g., downwardly toward the heat exchanger plate 44) of a base portion 60 of the locator 50. The base portion 60 may abut against the thermal interface material 56, and the projecting prong 54 may extend through the thermal interface material 56 in order to be accommodated within the slot 52. However, other configurations are contemplated within the scope of this disclosure.

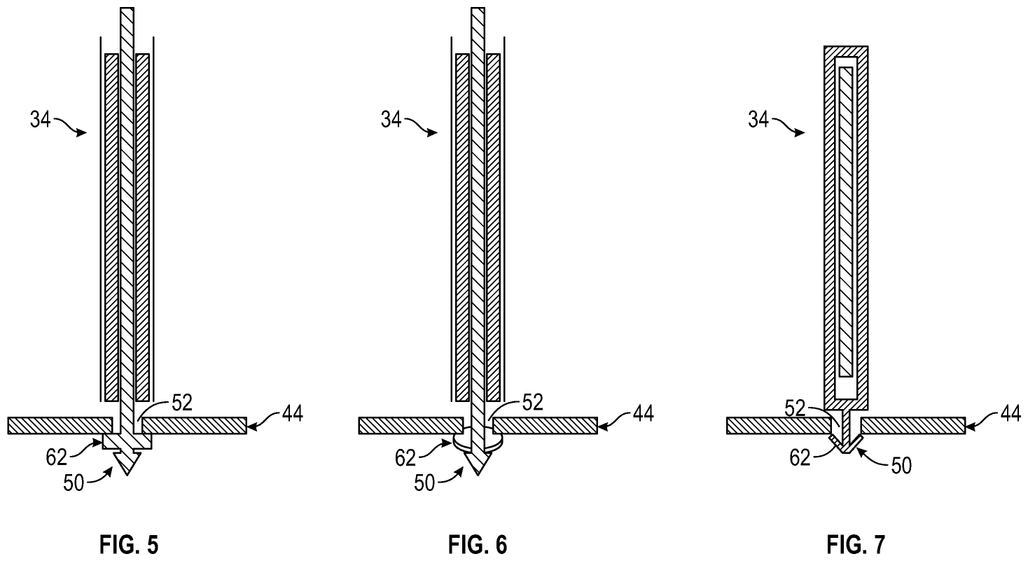

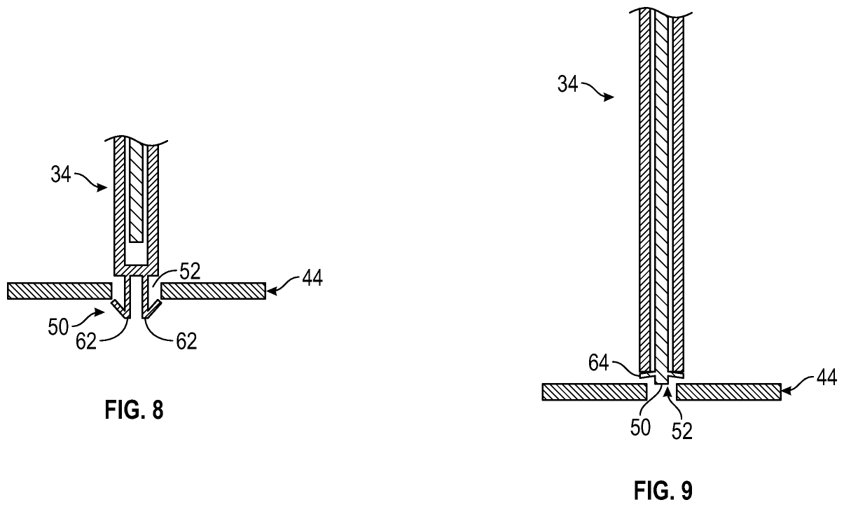

In other implementations, the locator 50 of the thermal barrier assembly 34 may include a retaining feature 62 for retaining the thermal barrier assembly 34 relative to the heat exchanger plate 44. The retaining feature 62 could be configured as a disk (see FIG. 5), an adhesive (see FIG. 6), a single prong (see FIG. 7), multiple prongs (see FIG. 8), etc. The retaining feature 62 is configured to permit the locator 50 to pass through the slot 52 while also preventing the locator 50 from subsequently backing out of the slot 52.

In still other implementations, the locator 50 may include a seal 64 (see FIG. 9). The seal 64 may be configured to seal an interface between the thermal barrier assembly 34 and the heat exchanger plate 44.

The exemplary traction battery packs of this disclosure include thermal barrier assemblies that include locating features for establishing an interface between the thermal barrier assembly and a heat exchanger plate of the traction battery pack. In addition to providing locating functions, the locating features are configured to at least partially fill and seal a slot formed in the heat exchanger plate. The thermal barrier assemblies may provide numerous advantages over known solutions, including but not limited to reducing assembly complexities and significantly slowing or even preventing cell-to-cell, compartment-to-compartment, and/or cell stack-to-cell stack transfer of a battery thermal event.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack;
a thermal barrier assembly arranged between a first battery cell and a second battery cell of the cell stack;
a heat exchanger plate positioned adjacent to the cell stack; and
a locator of the thermal barrier assembly received within a slot of the heat exchanger plate.

2. The traction battery pack as recited in claim 1, wherein the first battery cell, the second battery cell, and the thermal barrier assembly are arranged between a first cross-member beam and a second cross-member of the cell stack.

3. The traction battery pack as recited in claim 2, comprising a third cross-member beam adjacent to the first cross-member beam, wherein the first cross-member beam and the third cross-member beam establish a cross-member assembly arranged between the cell stack and a second cell stack of the traction battery pack.

4. The traction battery pack as recited in claim 3, comprising a venting passageway disposed between the first cross-member beam and the third cross-member beam.

5. The traction battery pack as recited in claim 1, wherein the thermal barrier assembly includes a fin section configured to interface with an enclosure cover.

6. The traction battery pack as recited in claim 5, wherein the fin section is located on an opposite end of the thermal barrier assembly from the locator.

7. The traction battery pack as recited in claim 5, wherein the fin section is secured to the enclosure cover by an adhesive.

8. The traction battery pack as recited in claim 1, comprising a thermal interface material between the cell stack and the heat exchanger plate.

9. The traction battery pack as recited in claim 8, wherein a projecting prong of the locator extends through the thermal interface material and at least partially fills the slot.

10. The traction battery pack as recited in claim 1, wherein the slot establishes a thermal break between the first battery cell and the second battery cell.

11. The traction battery pack as recited in claim 1, wherein the locator includes a solid plastic.

12. The traction battery pack as recited in claim 1, wherein the locator includes a compliant rubber.

13. A traction battery pack, comprising:
a cell stack;
a thermal barrier assembly arranged between a first battery cell and a second battery cell of the cell stack;
a heat exchanger plate positioned adjacent to the cell stack and including a slot configured to establish a thermal break between the first battery cell and the second battery cell; and
a locator of thermal barrier assembly positioned to at least partially fill the slot.

14. The traction battery pack as recited in claim 13, wherein the thermal barrier assembly includes a fin section configured to interface with an enclosure cover.

15. The traction battery pack as recited in claim 14, wherein the fin section is located on an opposite end of the thermal barrier assembly from the locator.

16. The traction battery pack as recited in claim 13, comprising a thermal interface material between the cell stack and the heat exchanger plate.

17. The traction battery pack as recited in claim 16, wherein a projecting prong of the locator extends through the thermal interface material and at least partially fills the slot.

18. The traction battery pack as recited in claim 17, wherein the projecting prong protrudes outwardly from a base portion of the locator.

19. The traction battery pack as recited in claim 13, wherein the locator includes a solid plastic.

20. The traction battery pack as recited in claim 13, wherein the locator includes a compliant rubber.
